(19) United States
(12) Patent Application Publication
(10) Pub. No.: US 2019/0074527 A1
(43) Pub. Date: Mar. 7, 2019

(54) FUEL CELL SYSTEM

(71) Applicant: KABUSHIKI KAISHA TOYOTA JIDOSHOKKI, Aichi (JP)

(72) Inventors: Junya SUZUKI, Aichi-ken (JP); Kazuki OKAZAKI, Aichi-ken (JP); Hidefumi MORI, Aichi-ken (JP)

(73) Assignee: KABUSHIKI KAISHA TOYOTA JIDOSHOKKI, Aichi (JP)

(21) Appl. No.: 16/119,582

(22) Filed: Aug. 31, 2018

(30) Foreign Application Priority Data
Sep. 7, 2017 (JP) 2017-171957

(51) Int. Cl. H01M 8/04111; H01M 8/04082; F04D 25/06; F04D 25/04; F04C 29/00

(52) U.S. Cl. CPC H01M 8/04111; H01M 8/04201; F04D 25/06; F04D 29/057; F04C 29/0085; F04C 2240/54; F04D 25/04

(57) ABSTRACT

A fuel cell system includes a bypass passage, a flow path selector portion that selects a flow path of oxidation gas, and a valve opening adjusting portion that adjusts an opening of a pressure adjusting valve. Until a rotation speed of a rotary shaft reaches a separation rotation speed at which the rotary shaft is separated from an aerodynamic bearing, the flow path selector portion permits flow of the oxidation gas from an electric compressor to a fuel cell stack through a supply passage and flow of the oxidation gas from the electric compressor to a discharge passage through the supply passage and the bypass passage, and the valve opening adjusting portion adjusts the opening of a pressure adjusting valve so that an efficiency of a turbine is maximized by the discharge gas.

### BACKGROUND ART

The present disclosure relates to a fuel cell system.

Vehicles having a fuel cell system that includes a fuel cell stack have now been put into practical use. In a fuel cell system, electrochemical reaction between hydrogen as a fuel gas and oxygen in the air as oxidation gas is caused to thereby generate electric power. Generally, a fuel cell system includes an electric compressor that compresses air. The electric compressor includes a housing, a rotary shaft disposed in the housing, an electric motor that is disposed in the housing and rotates the rotary shaft, and a compression portion that is disposed in the housing and is driven by the rotation of the rotary shaft to thereby compress air.

In some cases, a fuel cell system includes a turbine which has a turbine wheel that is rotated by discharge gas discharged from the fuel cell stack. The turbine wheel is coupled coaxially to the rotary shaft of the electric compressor. In such fuel cell system, the turbine wheel is rotated by the discharge gas. With this operation, kinetic energy of the discharge gas is converted into rotational energy. The rotational energy generated in the turbine reduces the load on the electric motor that rotates the rotary shaft. Thus, the energy consumption of the electric motor required for rotating the rotary shaft is reduced.

The turbine includes a turbine chamber in which the turbine wheel is disposed, and a pressure adjusting valve (a nozzle vane) with which an area of cross section of a passage that is connected to the turbine chamber is varied to thereby control or adjust the pressure of the discharge gas that is introduced into the turbine chamber. The pressure adjusting valve is configured to control the rotation speed of the turbine wheel by controlling the pressure of the discharge gas introduced into the turbine chamber. Furthermore, in the fuel cell system, pressure of air to be supplied to the fuel cell stack is adjusted in order to adjust the relative humidity in the fuel cell stack. The control of the pressure of air supplied to the fuel cell stack is achieved by adjusting the cross-sectional area of the passage connected to the turbine chamber by means of the pressure adjusting valve.

In a fuel cell system, electric power is generated by supplying hydrogen and air to the fuel cell stack and causing an electrochemical reaction between the hydrogen and oxygen. Therefore, electric power generation efficiency of the fuel cell stack may lower if oil or the like is mixed into the air and the hydrogen that are to be supplied to the fuel cell stack. In order to prevent such problem, the fuel cell system according to Japanese Patent Application Publication No. 2013-93134 employs aerodynamic bearings that do not require lubricant oil for rotatably supporting the rotary shaft relative to the housing. The aerodynamic bearings support the rotary shaft by contacting until the rotation speed of the rotary shaft reaches a specified rotation speed. When the rotation speed of the rotary shaft reaches the specified value, a dynamic pressure is generated between the rotary shaft and the aerodynamic bearings and the rotary shaft is separated from the aerodynamic bearings by the dynamic pressure. In this way, the rotary shaft is supported by the aerodynamic bearing without contacting with the aerodynamic bearing.

If, however, aerodynamic bearings are used in a fuel cell system, the rotary shaft is rotated while being in contact with the aerodynamic bearings until the rotation speed of the rotary shaft reaches a specified rotation speed at which the rotary shaft is separated from the aerodynamic bearings.

Furthermore, due to the fact that the rotary shaft is rotated while being in contact with the aerodynamic bearings until the specified rotation speed is reached, the longer it takes to reach the specified rotation speed of the rotary shaft, the longer is the time during which the rotary shaft slides relative to the aerodynamic bearings, which lowers the durability of the rotary shaft and the aerodynamic bearings. Therefore, the period of time for which the rotation speed of the rotary shaft reaches the specified rotation speed at which the rotary shaft is separated from the aerodynamic bearings should preferably be as short as possible. However, if the rotation speed of the rotary shaft is raised rapidly for that purpose, air compressed in the compression portion of the electric compressor is excessively supplied to the fuel cell stack and the relative humidity in the fuel cell stack drops, which lowers the electric power generation efficiency of the fuel cell stack.

The present disclosure, which has been made in view of the above circumstances, is directed to providing a fuel cell system that reduces power consumption of the electric motor and prevents drop in the electric power generation efficiency of the fuel cell stack.

### SUMMARY

In accordance with an aspect of the present disclosure, there is provided a fuel cell system that includes an electric compressor that compresses oxidation gas, a fuel cell stack to which the oxidation gas that is compressed in the electric compressor is supplied and which generates electric power using the supplied oxidation gas, a turbine that includes a turbine wheel that is rotated by discharge gas discharged from the fuel cell stack, a supply passage that provides connection between the electric compressor and the fuel cell stack and supplies the oxidation gas compressed in the electric compressor to the fuel cell stack, and a discharge passage that provides connection between the fuel cell stack and the turbine and through which the discharge gas that is discharged from the fuel cell stack flows. The electric compressor includes a housing, a rotary shaft disposed in the housing, an electric motor that is disposed in the housing and rotates the rotary shaft, and a compression portion that is disposed in the housing, connected to the rotary shaft, and driven by rotation of the rotary shaft to compress the oxidation gas. The turbine wheel is mounted on the rotary shaft and rotated by the discharge gas. The turbine includes a turbine chamber in which the turbine wheel is disposed, an introducing passage that provides connection between the turbine chamber and the discharge passage and introduces the discharge gas flowing in the discharge passage into the turbine chamber, and a pressure adjusting valve that adjusts an area of cross section of the introducing passage so as to adjust a pressure of the oxidation gas to be supplied to the fuel cell stack. The rotary shaft is supported by an aerodynamic bearing so that the rotary shaft is rotatable relative to the housing. The fuel cell system includes a bypass passage, a flow path selector portion, and a valve opening adjusting portion. The bypass passage bypasses the fuel cell stack and provides connection between the supply passage and the discharge passage.

The flow path selector portion selects a flow path of the oxidation gas. The valve opening adjusting portion adjusts an opening of the pressure adjusting valve to adjust a flow rate of the discharge gas that is introduced into the turbine chamber through the introducing passage. Until a rotation speed of the rotary shaft reaches a separation rotation speed at which the rotary shaft is separated from the aerodynamic bearing, the flow path selector portion permits flow of the oxidation gas from the electric compressor to the fuel cell stack through the supply passage and flow of the oxidation gas from the electric compressor to the discharge passage through the supply passage and the bypass passage, and the valve opening adjusting portion adjusts the opening of the pressure adjusting valve so that an efficiency of the turbine is maximized by the discharge gas.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic diagram of a fuel cell system according to an embodiment of the present disclosure; and

FIG. 2 is a schematic diagram of a fuel cell system according to a modification of the embodiment of the present disclosure.

### DETAILED DESCRIPTION OF THE EMBODIMENTS

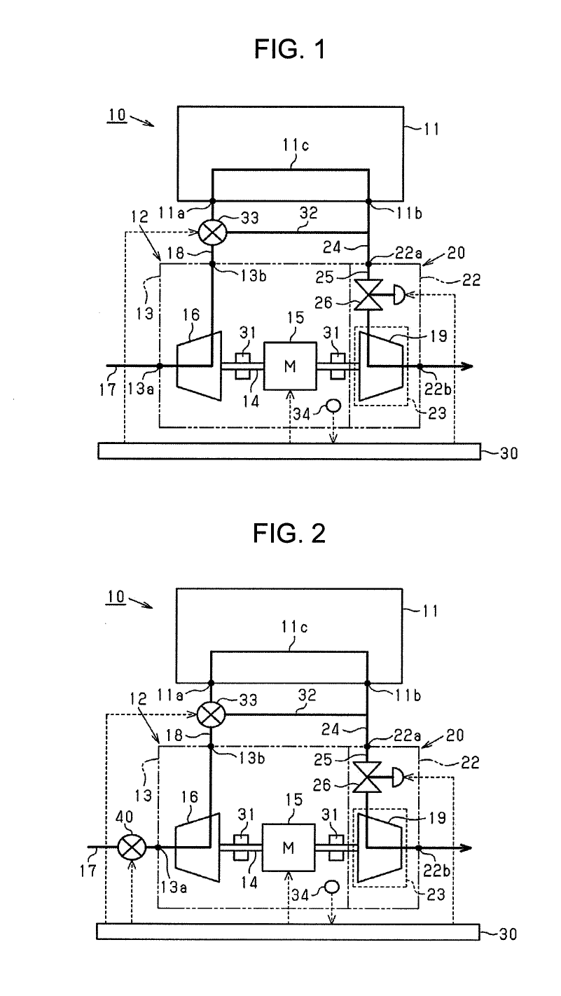

A fuel cell system according to an embodiment of the present disclosure will now be described with reference to FIG. 1. The fuel cell system according to the present embodiment is mounted on a vehicle, such as a fuel cell vehicle.

Referring to FIG. 1, a fuel cell system 10 includes a fuel cell stack 11 and an electric compressor 12 that compresses air, which is an oxidation gas. Air that is compressed in the electric compressor 12 is supplied to the fuel cell stack 11. The fuel cell stack 11 includes, for example, a plurality of cells. Each cell is formed by laminating an oxygen electrode, a hydrogen electrode, and an electrolyte membrane disposed between the oxygen electrode and the hydrogen electrode. In the fuel cell stack 11, an electrochemical reaction between hydrogen as fuel gas and oxygen contained in the air is caused to generate electric power. It is noted that, as long as the gas contains oxygen, any gas may be selected for the oxidation gas used for electric power generation.

The fuel cell stack 11 is electrically connected to a traction motor (not shown). The traction motor uses as its power source the electric power generated in the fuel cell stack 11. The kinetic power of the traction motor is transmitted to an axle of the vehicle through a power transmission mechanism (not shown), so that the vehicle travels at a vehicle speed that is based on the opening of the accelerator pedal of the vehicle.

Atmospheric air contains approximately 20% oxygen by volume. That is, 20% of the air (i.e., oxygen) that is supplied to the fuel cell stack 11 contributes to the electric power generation in the fuel cell stack 11, and the remaining 80% of the air that has no contribution to the electric power generation is discharged from the fuel cell stack 11 as discharge gas.

The fuel cell stack 11 includes a supply port 11a through which air is supplied, a discharge port 11b through which air is discharged as discharge gas, and an air passage 11c that provides connection between the supply port 11a and the discharge port 11b. The air that is supplied through the supply port 11a flows to the discharge port 11b through the air passage 11c.

The electric compressor 12 includes a housing 13, a rotary shaft 14 disposed in the housing 13, an electric motor 15 that is disposed in the housing 13 and rotates the rotary shaft 14, and a compression portion 16 that is disposed in the housing 13 and connected to the rotary shaft 14. With the rotation of the rotary shaft 14, the compression portion 16 is driven to compress air.

The electric motor 15 is driven by electric power supplied from a battery (not shown) and rotates the rotary shaft 14. The compression portion 16 according to the present embodiment is an impeller that is connected to a first end of the rotary shaft 14 for integral rotation therewith. With the rotation of the impeller, the compression operation takes place in the electric compressor 12. It is to be noted that the type of the compression portion 16 is not particularly limited to the impeller type of the present embodiment, and the compressor may be of a scroll type or a roots type.

The housing 13 includes a suction port 13a through which air is taken, and a discharge port 13b through which air is discharged. The fuel cell system 10 further includes a compressor passage 17 for the electric compressor 12. The compressor passage 17 is formed by a pipe or the like. One end of the compressor passage 17 is opened to the atmosphere, and the other end of the compressor passage 17 is connected to the suction port 13a. Air from the outside flows into the compressor passage 17 and is taken in through the suction port 13a. The compression portion 16 compresses the air that is taken in through the suction port 13a. Then, the air that is compressed in the compression portion 16 is discharged through the discharge port 13b.

The fuel cell system 10 includes a supply passage 18 that provides connection between the electric compressor 12 and the fuel cell stack 11. The supply passage 18 is formed by a pipe or the like. One end of the supply passage 18 is connected to the discharge port 13b, and the other end of the supply passage 18 is connected to the supply port 11a. The air discharged through the discharge port 13b flows through the supply passage 18 and is supplied to the supply port 11a. Therefore, the supply passage 18 provides connection between the electric compressor 12 and the fuel cell stack 11 and also supplies air that is compressed in the electric compressor 12 to the fuel cell stack 11.

The fuel cell system 10 includes a turbine 20 which has a turbine wheel 19 and a turbine housing 22. The turbine wheel 19 is rotated by discharge gas discharged from the fuel cell stack 11. The turbine housing 22 is connected to a second end of the rotary shaft 14 in the housing 13. That is, in the present embodiment, the electric compressor 12 and the turbine 20 are integrated.

The turbine 20 further has a turbine chamber 23 that is formed within the turbine housing 22. The turbine wheel 19 is disposed in the turbine chamber 23. The second end of the rotary shaft 14 extends from the housing 13 into the turbine chamber 23. The second end of the rotary shaft 14 is connected to the turbine wheel 19 in the turbine chamber 23. Thus, the turbine wheel 19 is mounted on the rotary shaft 14 and rotated by the discharge gas. The turbine wheel 19 is an impeller with blades.

The turbine housing 22 includes an inlet port 22a through which discharge gas is introduced, and a discharge port 22b through which discharge gas that has passed through the turbine chamber 23 is discharged. The fuel cell system 10 includes a discharge passage 24 that provides connection between the fuel cell stack 11 and the turbine 20. The discharge passage 24 is formed by a pipe or the like. One end of the discharge passage 24 is connected to the discharge port 11b, and the other end of the discharge passage 24 is connected to the inlet port 22a. Discharge gas that is discharged through the discharge port 11b flows through the discharge passage 24, and then is introduced into the inlet port 22a. Thus, the discharge passage 24 is a passage that provides connection between the fuel cell stack 11 and the turbine 20 and through which discharge gas that is discharged from the from the fuel cell stack 11 flows.

The turbine 20 includes an introducing passage 25 that provides connection between the turbine chamber 23 and the discharge passage 24 and that introduces discharge gas flowing in the discharge passage 24 into the turbine chamber 23. The introducing passage 25 is formed in the turbine housing 22 and provides communication between the inlet port 22a and the turbine chamber 23. Thus, the introducing passage 25 is connected to the discharge passage 24 via the inlet port 22a.

The turbine 20 includes a pressure adjusting valve 26 that controls or adjusts an area of cross section of the introducing passage 25 so as to control or adjust a pressure of air to be supplied to the fuel cell stack 11. The pressure adjusting valve 26 includes, for example, a plurality of nozzle vanes that are arranged in the circumferential direction along an outer periphery of the turbine wheel 19, and a rotor mechanism that rotates or turns the nozzle vanes. The cross-sectional area of the introducing passage 25 is adjusted by the turning of the nozzle vanes by the rotor mechanism.

The fuel cell stack 11 includes a controller 30. The controller 30 is electrically connected to the electric motor 15 and controls driving of the electric motor 15. The controller 30 is electrically connected to the pressure adjusting valve 26. The controller 30 calculates an amount of electric power that is required for the fuel cell stack 11 to generate, based, e.g., on a mode of operation of an accelerator pedal, and then determines a target opening of the pressure adjusting valve 26 based on the required electric power generation amount. Subsequently, the controller 30 controls or adjusts the opening of the pressure adjusting valve 26 to attain the determined target opening. In accordance with the control of the opening of the pressure adjusting valve 26 by the controller 30, the pressure of air to be supplied to the fuel cell stack 11 is adjusted. It is to be noted that the opening of the pressure adjusting valve 26 herein corresponds to the turn angle of the nozzle vanes. By the adjustment of the pressure of air to be supplied to the fuel cell stack 11, the relative humidity in the fuel cell stack 11 is adjusted. The relative humidity in the fuel cell stack 11 is adjusted to a predetermined value that is suitable for the fuel cell stack 11 to efficiently generate electric power.

Furthermore, by the adjustment of the cross-sectional area of the introducing passage 25 by the pressure adjusting valve 26, the pressure of the discharge gas that is introduced from the introducing passage 25 into the turbine chamber 23 is adjusted. Discharge gas that has passed through the pressure adjusting valve 26 is blown onto the turbine wheel 19, so that the turbine wheel 19 is rotated. In the turbine 20, a rotational energy is produced by the rotation of the turbine wheel 19 by the discharge gas. In other words, the kinetic energy of the discharge gas is converted into a rotational energy through the rotation of the turbine wheel 19. The rotational energy produced in the turbine 20 reduces the load on the electric motor 15 that rotates the rotary shaft 14.

The rotary shaft 14 is supported by a pair of aerodynamic bearings 31 so that the rotary shaft 14 is rotatable relative to the housing 13. In the present embodiment, the two aerodynamic bearings 31 are disposed opposite to each other across the electric motor 15 in an axial direction of the rotary shaft 14. Specifically, one of the aerodynamic bearings 31 is disposed between the compression portion 16 and the electric motor 15 and the other of the aerodynamic bearings 31 is disposed between the electric motor 15 and the turbine wheel 19 in the axial direction of the rotary shaft 14.

The aerodynamic bearings 31 support the rotary shaft 14 by contacting until the rotation speed of the rotary shaft 14 reaches a specified rotation speed. When the specified rotation speed of the rotary shaft 14 is reached, aerodynamic pressure is generated between the rotary shaft 14 and the aerodynamic bearings 31. Then, the rotary shaft 14 is separated from the aerodynamic bearings 31 by the aerodynamic pressure. In this state, the aerodynamic bearings 31 support the rotary shaft 14 in a non-contact manner.

The fuel cell system 10 includes a bypass passage 32 that bypasses the fuel cell stack 11 and provides connection between the supply passage 18 and the discharge passage 24 without passing through the fuel cell stack 11. The bypass passage 32 is formed by a pipe or the like. One end of the bypass passage 32 is connected to the supply passage 18 at a position between the supply port 11a and the discharge port 13b, and the other end of the supply passage 18 is connected to the discharge passage 24 at a position between the discharge port 11b and the inlet port 22a.

The fuel cell system 10 includes a three-way valve 33 that is disposed at a junction between the supply passage 18 and the bypass passage 32. The three-way valve 33 is electrically connected with the controller 30. The controller 30 controls or switches the position of the three-way valve 33.

The three-way valve 33 is switchable between a first position and a second position, and the switching between the first and second positions is controlled by the controller 30. When the three-way valve 33 is at the first position, air is permitted to flow from the electric compressor 12 to the fuel cell stack 11 through the supply passage 18 and also to flow from the electric compressor 12 to the discharge passage 24 through the bypass passage 32. When the three-way valve 33 is at the second position, the air flow from the electric compressor 12 to the fuel cell stack 11 through the supply passage 18 is permitted, and the air flow from the supply passage 18 to the discharge passage 24 is shut off.

The fuel cell system 10 further includes a rotation speed detector 34 that detects a rotation speed of the rotary shaft 14. The rotation speed detector 34 is electrically connected to the controller 30. The rotation speed detector 34 detects a rotation speed of the rotary shaft 14 and sends a signal indicative of the detected rotation speed to the controller 30.

After the three-way valve 33 is switched to the first position, the controller 30 controls the three-way valve 33 so that the three-way valve 33 remains at the first position until the rotation speed of the rotary shaft 14 that is detected by the rotation speed detector 34 reaches a rotation speed at which the rotary shaft 14 is separated from the aerodynamic bearings 31 (hereinafter, referred to as the separation rotation speed). Therefore, the controller 30 and the three-way valve 33 cooperate to form a flow path selector portion that selects a flow path of air and that, until the rotation speed of the rotary shaft 14 reaches the separation rotation speed, permits flow of air from the electric compressor 12 to the fuel cell stack 11 through the supply passage 18 and flow of air from the electric compressor 12 to the discharge passage 24 through the supply passage 18 and the bypass passage 32.

The controller 30 also adjusts or controls the opening of the pressure adjusting valve 26 to adjust the flow rate of the discharge gas that is introduced into the turbine chamber 23 through the introducing passage 25 to attain a maximum efficiency of the turbine 20 by means of the discharge gas, until the rotation speed of the rotary shaft 14 reaches the separation rotation speed detected by the rotation speed detector 34. Thus, the controller 30 also forms a valve opening adjusting portion that adjusts the opening of the pressure adjusting valve 26 to adjust the flow rate of the discharge gas that is introduced into the turbine chamber 23 through the introducing passage 25 and that, until the rotation speed of the rotary shaft 14 reaches the separation rotation speed, adjusts the opening of the pressure adjusting valve 26 so that the efficiency of the turbine 20 is maximized by the discharge gas. It is to be noted that in the following description, the efficiency of the turbine 20 is simply referred to as the turbine efficiency.

The turbine efficiency herein refers to a ratio of the kinetic energy of the discharge gas that is converted into a rotational energy through the rotation of the turbine wheel 19. That is, the turbine efficiency indicates the performance of the turbine 20 itself.

In the above description that the opening of the pressure adjusting valve 26 is controlled by the controller 30 (i.e., the valve opening adjusting portion) and the flow rate of the discharge gas that is introduced into the turbine chamber 23 through the introducing passage 25 is adjusted so that the efficiency of the turbine 20 (i.e., the turbine efficiency) is maximized by the discharge gas, the opening of the pressure adjusting valve 26 after being controlled by the controller 30 corresponds to an opening of the pressure adjusting valve 26 which creates an optimum flow rate of the discharge gas that is to be blown onto the blades of the turbine wheel 19. This opening of the pressure adjusting valve 26 is predetermined in accordance with the geometry of the blades of the turbine wheel 19 and the like.

The following will describe the operation of the present embodiment. At a start of the fuel cell system 10, the controller 30 switches the three-way valve 33 to the first position. The controller 30 also controls the opening of the pressure adjusting valve 26 and adjusts the flow rate of the discharge gas that is introduced into the turbine chamber 23 through the introducing passage 25 to attain a maximum turbine efficiency by means of the discharge gas, and the turbine wheel 19 is rotated by the discharge gas blown onto the turbine wheel 19.

Subsequently, the controller 30 controls the driving of the electric motor 15 to rotate the rotary shaft 14, which then drives the compression portion 16, and air that is taken into the electric compressor 12 through the compressor passage 17 and the suction port 13a is compressed in the compression portion 16. The air compressed in the compression portion 16 is then supplied from the electric compressor 12 to the fuel cell stack 11 through the discharge port 13b and the supply passage 18. Since the three-way valve 33 is at the first position, part of the air flowing in the supply passage 18 is re-directed at the three-way valve 33 to flow into the bypass passage 32 and then to flow in the discharge passage 24 as the discharge gas.

The discharge gas that is discharged from the fuel cell stack 11 to the discharge passage 24 and the air as the discharge gas that is delivered from the supply passage 18 to the discharge passage 24 through the bypass passage 32 are introduced into the turbine chamber 23 through the inlet port 22a and the introducing passage 25. Then, the turbine wheel 19 is rotated by the discharge gas introduced into the turbine chamber 23. The discharge gas that has exited from the turbine chamber 23 is discharged to the outside through the discharge port 22b.

The controller 30 controls the opening of the pressure adjusting valve 26 and adjusts the flow rate of the discharge gas that is introduced into the turbine chamber 23 through the introducing passage 25 to attain a maximum turbine efficiency by means of the discharge gas, until the rotation speed of the rotary shaft 14 reaches the separation rotation speed, and the turbine wheel 19 is rotated by the discharge gas. Thus, for the period of time until the rotation speed of the rotary shaft 14 that is detected by the rotation speed detector 34 reaches the separation rotation speed, the controller 30 adjusts the opening of the pressure adjusting valve 26 so that the turbine efficiency is maximized, and the rotational energy produced by the rotation of the turbine wheel 19 reduces the load on the electric motor 15 that rotates the rotary shaft 14.

Furthermore, after the three-way valve 33 is switched to the first position, the controller 30 controls the three-way valve 33 so that the three-way valve 33 remains at the first position until the rotation speed of the rotary shaft 14 that is detected by the rotation speed detector 34 reaches the separation rotation speed. For the period of time until the rotation speed of the rotary shaft 14 reaches the separation rotation speed, part of the air flowing in the supply passage 18 is delivered to the discharge passage 24 through the bypass passage 32. Therefore, during this period, the air compressed in the compression portion 16 of the electric compressor 12 is prevented from being supplied excessively to the fuel cell stack 11. As a result, drop in the relative humidity in the fuel cell stack 11 is prevented, and therefore drop in the electric power generation efficiency of the fuel cell stack 11 is prevented.

When the rotation speed detector 34 detects that the rotation speed of the rotary shaft 14 has reached the separation rotation speed, the controller 30 switches the three-way valve 33 to the second position. Specifically, after the separation rotation speed of the rotary shaft 14 is reached, the controller 30 and the three-way valve 33 that cooperate form the flow path selector portion permit the flow of air from the electric compressor 12 to the fuel cell stack 11 through the supply passage 18, and shuts off the flow of air from the electric compressor 12 to the discharge passage 24 through the supply passage 18 and the bypass passage 32. With this configuration, substantially the whole of the air compressed in the compression portion 16 of the electric compressor 12 is supplied from the electric compressor 12 to the fuel cell stack 11 through the supply passage 18.

When the rotation speed detector 34 detects that the rotation speed of the rotary shaft 14 has reached the separation rotation speed, the controller 30 controls the opening of the pressure adjusting valve 26 to attain the target opening that is determined based on the required electric power generation amount that is required for the fuel cell stack 11. In other words, after the separation rotation speed of the rotary shaft 14 is reached, the controller 30 adjusts the opening of the pressure adjusting valve 26 so that the fuel cell stack 11 generates the required amount of electric power that is required for the fuel cell stack 11. With this control, electric power generation takes place in the fuel cell stack 11 in accordance with the required electric power generation amount that is calculated by the controller 30.

The present embodiment offers the following effects:

(1) For the period of time until the rotation speed of the rotary shaft 14 reaches the separation rotation speed, the controller 30 controls or adjusts the opening of the pressure adjusting valve 26 so that the turbine efficiency is maximized, and the turbine wheel 19 is rotated by the discharge gas. Therefore, the rotational energy produced by the rotation of the turbine wheel 19 reduces the load on the electric motor 15 that rotates the rotary shaft 14, so that the power consumption of the electric motor 15 required for rotating the rotary shaft 14 is reduced. For the period of time until the rotation speed of the rotary shaft 14 reaches the separation rotation speed, part of the air flowing in the supply passage 18 is delivered to the discharge passage 24 through the bypass passage 32. Therefore, during this period, air compressed in the compression portion 16 of the electric compressor 12 is prevented from being supplied excessively to the fuel cell stack 11. As a result, drop in the relative humidity in the fuel cell stack 11 is prevented and therefore drop in the electric power generation efficiency of the fuel cell stack 11 is prevented.

(2) After the separation rotation speed of the rotary shaft 14 is reached, the controller 30 and the three-way valve 33 permit the flow of air from the electric compressor 12 to the fuel cell stack 11 through the supply passage 18, and shut off the flow of air from the electric compressor 12 to the discharge passage 24 through the supply passage 18 and the bypass passage 32. Thus, after the separation rotation speed of the rotary shaft 14 is reached, it is possible to supply the whole of the air compressed in the compression portion 16 of the electric compressor 12 from the electric compressor 12 to the fuel cell stack 11 through the supply passage 18.

(3) After the separation rotation speed of the rotary shaft 14 is reached, the controller 30 adjusts the opening of the pressure adjusting valve 26 so that the fuel cell stack 11 generates the required amount of electric power that is required for the fuel cell stack 11. Therefore, after the separation rotation speed of the rotary shaft 14 is reached, it is possible to generate electric power in the fuel cell stack 11 in accordance with the required electric power generation amount.

(4) For the period of time until the rotation speed of the rotary shaft 14 reaches the separation rotation speed, the turbine wheel 19 is rotated at a speed that maximizes the turbine efficiency. Therefore, the time until the separation rotation speed of the rotary shaft 14 is reached may be reduced as much as possible, so that the duration of time during which the rotary shaft 14 slides relative to the aerodynamic bearings 31 is reduced. As a result, the durability of the rotary shaft 14 and the aerodynamic bearings 31 is improved.

The present embodiment of the present disclosure may be modified in the following manners:

As illustrated in FIG. 2, which shows a modification of the embodiment of the present disclosure, the compressor passage 17 may include a suction valve 40 that adjusts the flow rate of the air flowing in the compressor passage 17. In this case, the suction valve 40 is electrically connected to the controller 30. The controller 30 controls the opening of the suction valve 40. For the period of time until the rotation speed of the rotary shaft 14 reaches the separation rotation speed, the controller 30 reduces the opening of the suction valve 40 to reduce the amount of air to be taken into the electric compressor 12. With this configuration, during this period, the flow rate of air compressed in the compression portion 16 of the electric compressor 12 is reduced, which then reduces the power consumption of the electric motor 15 that rotates the rotary shaft 14 for driving the compression portion 16. Once the separation rotation speed of the rotary shaft 14 is reached, the controller 30 controls the suction valve 40 so that the suction valve 40 is fully opened.

In the modification of the embodiment of the present disclosure shown in FIG. 2, the opening of the suction valve 40 may be adjusted mechanically instead of controlling it electrically via the controller 30. For example, for the period of time until the rotation speed of the rotary shaft 14 reaches the separation rotation speed, the opening of the suction valve 40 may be controlled in the following manner: Part of the air compressed in the compression portion 16 is returned to the suction valve 40 so that the returned air acts on the valve body of the suction valve 40 as the backpressure to reduce the opening of the suction valve 40. This configuration further prevents the air compressed in the compression portion 16 of the electric compressor 12 from being supplied excessively to the fuel cell stack 11, for the period until the separation rotation speed of the rotary shaft 14 is reached. Furthermore, when the separation rotation speed of the rotary shaft 14 is reached, the returning of part of the air compressed in the compression portion 16 is shut off. Then, there is no backpressure acting on the valve body of the suction valve 40, so that the suction valve 40 is fully opened.

In the above embodiment and the modification thereof, the controller 30 may be configured to control the three-way valve 33 so that the three-way valve 33 remains at the first position even though the rotation speed detector 34 detects that the rotation speed of the rotary shaft 14 has reached the separation rotation speed, when the required electric power generation amount required for the fuel cell stack 11 is smaller than a specified value. With this configuration, when the required electric power generation amount required for the fuel cell stack 11 is smaller than the specified value, air compressed in the compression portion 16 of the electric compressor 12 is prevented from being supplied excessively to the fuel cell stack 11. As a result, drop in the relative humidity in the fuel cell stack 11 is prevented and therefore drop in the electric power generation efficiency of the fuel cell stack 11 is also prevented.

In the above embodiment and the modification thereof, the three-way valve 33 may not be disposed at the junction between the supply passage 18 and the bypass passage 32. Alternatively, a first flow rate control valve may be disposed at a position in the supply passage 18 that is closer to the fuel cell stack 11 than the junction between the supply passage 18 and the bypass passage 32 is, and a second flow rate control valve may be disposed in the bypass passage 32. In this case, for example, for the period of time until the separation rotation speed of the rotary shaft 14 is reached, the controller 30 controls the openings of the first and second flow rate control valves so that the opening of the first control valve is reduced and the second flow rate control valve is fully opened. With this configuration, air compressed in the compression portion 16 of the electric compressor 12 is prevented from being supplied excessively to the fuel cell stack 11, for the period until the separation rotation speed of the rotary shaft 14 is reached. Once the separation rotation speed of the rotary shaft 14 is reached, the controller 30, for example, controls the openings of the first and second flow rate control valves so that the first flow rate control valve is fully opened and the second flow rate control valve is closed. In this configuration, the controller 30, the first flow rate control valve, and the second flow rate control valve cooperate to form the flow path selector portion that selects a flow path of air and that, until the rotation speed of the rotary shaft 14 reaches the separation rotation speed, permits flow of the air from the electric compressor 12 to the fuel cell stack 11 through the supply passage 18 and flow of the air from the electric compressor 12 to the discharge passage 24 through the supply passage 18 and the bypass passage 32.

In the above embodiment and the modification thereof, for example, the controller 30 may be configured to estimate the rotation speed of the rotary shaft 14 from the power consumption of the electric motor 15, in order to determine whether the rotation speed of the rotary shaft 14 has reached the separation rotation speed or not. In this case, the controller 30 stores therein a map with which the controller 30 can estimate the rotation speed of the rotary shaft 14 from the power consumption of the electric motor 15.

The configuration of the pressure adjusting valve 26 is not particularly limited to the above embodiment and the modification thereof. The configuration of the pressure adjusting valve 26 may be optional as long as the pressure adjusting valve 26 can adjust the cross-sectional area of the introducing passage 25 to adjust the pressure of air to be supplied to the fuel cell stack 11.

In the above embodiment and the modification thereof, the application of the fuel cell system 10 is not limited to vehicles.

What is claimed is:

1. A fuel cell system comprising:
an electric compressor that compresses oxidation gas;
a fuel cell stack to which the oxidation gas that is compressed in the electric compressor is supplied and which generates electric power using the supplied oxidation gas;
a turbine that includes a turbine wheel that is rotated by discharge gas discharged from the fuel cell stack;
a supply passage that provides connection between the electric compressor and the fuel cell stack and supplies the oxidation gas compressed in the electric compressor to the fuel cell stack; and
a discharge passage that provides connection between the fuel cell stack and the turbine and through which the discharge gas that is discharged from the fuel cell stack flows,
the electric compressor including:
a housing;
a rotary shaft disposed in the housing;
an electric motor that is disposed in the housing and rotates the rotary shaft; and
a compression portion that is disposed in the housing, connected to the rotary shaft, and driven by rotation of the rotary shaft to compress the oxidation gas,
the turbine wheel being mounted on the rotary shaft and rotated by the discharge gas,
the turbine including:
a turbine chamber in which the turbine wheel is disposed;
an introducing passage that provides connection between the turbine chamber and the discharge passage and introduces the discharge gas flowing in the discharge passage into the turbine chamber; and
a pressure adjusting valve that adjusts an area of cross section of the introducing passage so as to adjust a pressure of the oxidation gas to be supplied to the fuel cell stack, and
the rotary shaft being supported by an aerodynamic bearing so that the rotary shaft is rotatable relative to the housing, wherein
the fuel cell system includes:
a bypass passage that bypasses the fuel cell stack and provides connection between the supply passage and the discharge passage;
a flow path selector portion that selects a flow path of the oxidation gas; and
a valve opening adjusting portion that adjusts an opening of the pressure adjusting valve to adjust a flow rate of the discharge gas that is introduced into the turbine chamber through the introducing passage, wherein
until a rotation speed of the rotary shaft reaches a separation rotation speed at which the rotary shaft is separated from the aerodynamic bearing, the flow path selector portion permits flow of the oxidation gas from the electric compressor to the fuel cell stack through the supply passage and flow of the oxidation gas from the electric compressor to the discharge passage through the supply passage and the bypass passage, and the valve opening adjusting portion adjusts the opening of the pressure adjusting valve so that an efficiency of the turbine is maximized by the discharge gas.

2. The fuel cell system according to claim 1, wherein
after the rotation speed of the rotary shaft reaches the separation rotation speed, the flow path selector portion permits the flow of the oxidation gas from the electric compressor to the fuel cell stack, and shuts off the flow of the oxidation gas from the electric compressor to the discharge passage through the supply passage and the bypass passage.

3. The fuel cell system according to claim 1, wherein
after the rotation speed of the rotary shaft reaches the separation rotation speed, the valve opening adjusting portion adjusts the opening of the pressure adjusting valve so that the fuel cell stack generates an amount of electric power that is required for the fuel cell stack.
